(19) United States
(12) Patent Application Publication
(10) Pub. No.: US 2017/0341610 A1
(43) Pub. Date: Nov. 30, 2017

(54) FULLY AUTOMATIC AUTOMOBILE FORDING RESCUE SYSTEM

(71) Applicant: Jie TU, Nanchang City, Jiangxi (CN)

(72) Inventor: Jie TU, Nanchang City, Jiangxi (CN)

(21) Appl. No.: 15/536,630

(22) PCT Filed: Jun. 2, 2016
(86) PCT No.: PCT/CN2016/084575

§ 371 Date: Jun. 15, 2017

(30) Foreign Application Priority Data
Jul. 20, 2015 (CN) 201510425097.5

(51) Int. Cl. B60R 21/01; B60R 21/20; B60R 21/00

(52) U.S. Cl. CPC B60R 21/01; B60R 21/20; B60R 2021/0016

(57) ABSTRACT

A rescue system includes an inflatable rescue cushion at the bottom of an automobile, which includes air cushion storage chambers in front, back, left, and right of the bottom of the automobile. A gas generator is correspondingly arranged in the air cushion storage chamber in each position, for inflating and opening air cushions in the corresponding air cushion storage chambers to form a front, back, left and right air cushion. The system also includes an electronic early warning and central processing collaboration part, which includes an external water level sensor, central collaborative processing unit, first grade early warning signal light, and a switch. The external water level sensor is connected to the central collaborative processing unit, which is connected to the warning signal light, the gas generator, and the automobile computer board. The switch is positioned in the automobile and is connected to the gas generators.

### BACKGROUND

### Technical Field

The present invention relates to a novel fully automatic automobile fording rescue system, which is a water-proof rescue system aiming at fully, automatically rescuing a compact passenger automobile when the automobile encounters burst water rise. The present invention is applicable to all compact automobiles, and is also applicable to hybrid power and electric compact automobiles.

### Related Art

In recent years, the transportation tools, that is, automobiles, develop and spread at an amazing speed, and bring about a great deal of convenience for people's lives. Meanwhile, due to factors such as global warming, extreme weathers occur frequently, and rainstorm, flood, or the like causes severe urban water-logging, and consequently automobile distress incidents occur occasionally, which sometimes may even threaten people's life safety. So, how to protect safety for life and property in face of burst natural disasters becomes an urgent subject to deal with. By means of case analysis of previous accidents, when dealing with an emergence, an individual generally smashes window glass of an automobile by using a hard object such as an emergency hammer and a heel of high-heeled shoe, discards the automobile, and escapes to a safe place, while watching their own automobile being overwhelmed by water.

For fording secure rescue systems for automatically finishing rescue or prompting an occupant to manually finish rescue at present, in some cases, an automobile is placed in a huge air bag to cut off contact with water. The method has its advantages, but also has disadvantages, for example, the operations are complicated, a relatively large site and great labor are needed, and the requirement for driving skills is also high. In case of a bust emergence, there are not ideal conditions for rescuing. In another method, a sealed space is enclosed around outer sides of an automobile by means of inflating, so as to cut off contact with water. The disadvantage of this method lies in that: when the water level is excessively high, the bottom of the automobile cannot be fully sealed, and consequently the automobile may still be submerged and immersed in water.

### SUMMARY

To resolve the foregoing technical problem, the present invention provides a novel fully automatic automobile fording rescue system. When an emergency occurs, rescue of automobile and occupant can be easily implemented by a manual operation of the occupant in the automobile or by an automatic operation of a central processing unit on the automobile.

To achieve the objective, the present invention provides a novel fully automatic automobile fording rescue system, where the system includes an inflatable rescue cushion at the bottom of an automobile and an electronic early warning and central processing collaboration part.

The inflatable rescue cushion includes air cushion storage chambers which are located at four positions in front, back, left, and right of the bottom of the automobile, a gas generator is correspondingly arranged in the air cushion storage chamber in each position, and the gas generators are used for inflating and opening air cushions in the corresponding air cushion storage chambers to form a front air cushion, a back air cushion, a left air cushion, and a right air cushion.

The electronic early warning and central processing collaboration part includes an external water level sensor, a central collaborative processing unit, a first grade early warning signal light, and a manual button switch.

The external water level sensor is connected to the central collaborative processing unit, the central collaborative processing unit is connected to the first grade early warning signal light, the gas generator, and the automobile computer board; the first grade early warning signal light is positioned in the automobile; and the manual button switch is positioned in the automobile and is connected to the gas generators.

The system further includes an internal water level sensor located at the inflatable rescue cushion, where the internal water level sensor is connected to the central collaborative processing unit.

The system further includes a second grade early warning signal light positioned in the automobile, where the second grade early warning signal light is connected to the central collaborative processing unit.

The assembled inflatable rescue cushion having four notches is disposed at corresponding positions in front, back, left, and right of the lower surface of the base plate of the automobile.

When the four air cushions of the inflatable rescue cushion are opened, edge portions thereof are located on outer sides of edges of the automobile and extend upwards by 20 to 30 cm.

The air cushions are made of a water-proof composite material.

The air cushions are made of a water-proof composite material of TPU nylon.

The present invention differs from the prior art in achieving the following technical effects:

By means of the present invention, rescue of automobile and occupant can be easily implemented by a manual operation of the occupant in the automobile or by an automatic operation of a central processing unit on the automobile when an emergency occurs. The present invention is a water-proof rescue system aiming at fully, automatically rescuing a compact passenger automobile when the automobile encounters burst water rise. The present invention is applicable to all compact automobiles, and is also applicable to hybrid power and electric compact automobiles.

The following further describes the present invention with reference to the accompanying drawings.

### BRIEF DESCRIPTION OF THE DRAWINGS

FIG. 1 is a schematic structural diagram of a novel fully automatic automobile fording rescue system; and

FIG. 2 is a schematic use status diagram of a novel fully automatic automobile fording rescue system.

Description of reference numerals: 1—front air cushion; 2—left air cushion; 3—back air cushion; 4—right air cushion; 5—external water level sensor; 6—internal water level sensor; 7—central collaborative processing unit; 8—air cushion storage chamber; 9—gas generator; 101—right front tire clamping notch; 102—left front tire clamping notch; 103—right rear tire clamping notch; 104—left rear tire clamping notch.

### DETAILED DESCRIPTION

The following further describes the foregoing and other technical features and advantages of the present invention in detail in the embodiments.

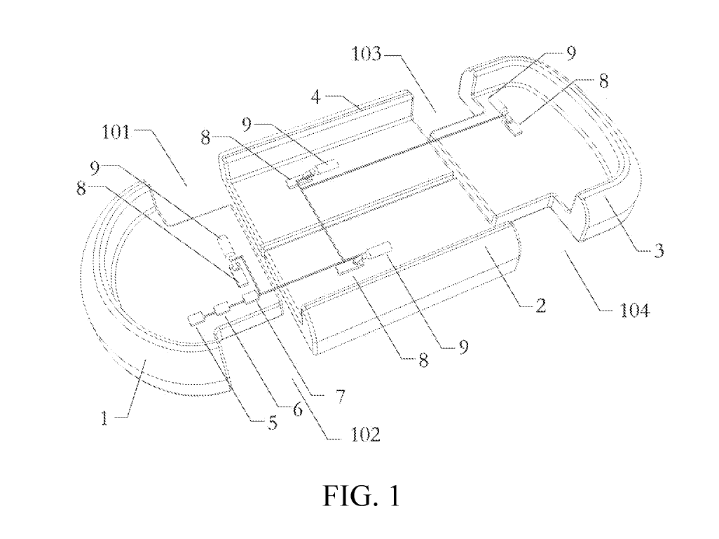

As shown in FIG. 1, the present invention provides a novel fully automatic automobile fording rescue system. The system includes an inflatable rescue cushion at the bottom of an automobile and an electronic early warning and central processing collaboration part.

The inflatable rescue cushion includes air cushion storage chambers 8 which are located at four positions in front, back, left, and right of the bottom of the automobile, a gas generator 9 is correspondingly arranged in the air cushion storage chamber 8 in each position, and the gas generators 9 are used for inflating and opening air cushions in the corresponding air cushion storage chambers 8 to form a front air cushion 1, a back air cushion 3, a left air cushion 2, and a right air cushion 4. The air cushions are made of a water-proof composite material of TPU nylon.

The electronic early warning and central processing collaboration part includes an external water level sensor 5, an internal water level sensor 6, a central collaborative processing unit 7, a first grade early warning signal light, a second grade early warning signal light, and a manual button switch.

When the automobile fords in water by a height of ⅓ tire height, the external water level sensor 5 positioned near a front wheel brake first detects the water level. When the automobile fords in water by a height close to the bottom of the automobile, the internal water level sensor 6 positioned behind a front wheel mudguard detects the water level. The two sensors are respectively positioned at high and low positions of the bottom, and are separately connected to the central collaborative processing unit 7. The central collaborative processing unit 7 is connected to the gas generator 8, an automobile computer board, and the first grade early warning signal light and the second grade early warning signal light that are positioned in the automobile. The manual button switch is positioned in the automobile and is connected to the gas generators 9. A right front tire clamping notch 101, a left front tire clamping notch 102, a right rear tire clamping notch 103, and a left rear tire clamping notch 104 are provided at the inflatable rescue cushion corresponding to tires of the automobile. When the four air cushions of the inflatable rescue cushion are opened, edge portions thereof are located on outer sides of edges of the automobile and extend upwards by 20 to 30 cm.

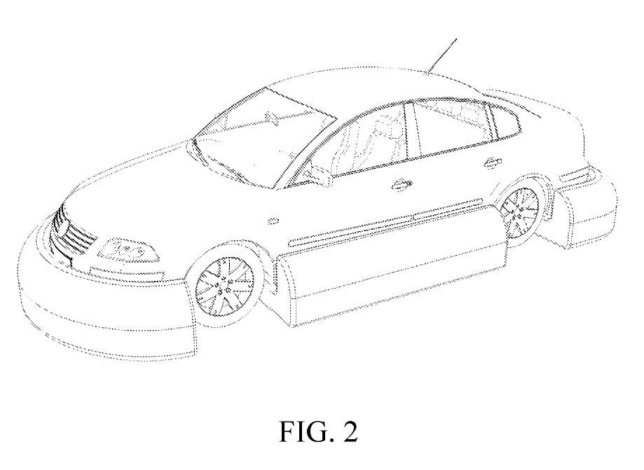

FIG. 2 is a schematic use status diagram for use of the system in an automobile of the present invention.

The inflatable rescue cushion is constructed by four sealed air bags at front, back, left, and right sides. An automobile is lifted up and floats on water by using buoyant force characteristics. According to the buoyant force principles and characteristics, theoretically buoyant force generated by one cubic meter can enable one ton of object to float on water. According to calculation based on household cars of general size, if the automobile is at a height of 0.15 m from the ground, the whole length of the rescue cushion at the bottom of the automobile is 5 m, and the whole width thereof is 2.2 m, the obtained volume is approximately 1.65 cubic meters. Moreover, the household automobiles each have a weight of approximately 1.4 to 1.5 tons. The calculated value of the volume is slightly greater than the value of the weight of the vehicle, and rescuing by means of the rescue cushion can be implemented. In order to better and safer implement the protection and rescue function, the rescue cushion at the bottom is designed to spread in all sides and extend upwards by 20 to 30 cm, by way of which not only a greater volume (buoyant force) can be obtained, but also damage of automobiles caused by collision therebetween due to wandering when the automobiles float on water can be avoided, playing a function of an anti-collision wall. The structure can be seen in FIG. 1. The four notches of the rescue cushion at the positions of the tires are also a key to implementation of the present invention. The four notches exactly enable the tires to be received in the rescue cushion, such that the rescue cushion contacts the whole base plate of the automobile, thereby generating a uniform upwards force. If the rescue cushion is a complete rectangular rescue cushion without notches, the contacts may be on the four wheels, which may probably causes risks of rollover.

When the automobile encounters water of a high level or accidentally falls into water in the riding state, the external water level sensor 5 obtains the signal, the central collaborative processing unit 7 then processes the signal and immediately sends an instruction to the automobile computer board (ECU) for turning off the engine, so to avoid damage of the engine, and accordingly the first grade early warning signal light also illuminates. At this time, an occupant gets prepared for rescuing. If conditions permit, the occupant leaves the dangerous area in time. If withdrawal is not possible in a critical condition, the occupant immediately presses the manual button switch, such that four sets of air cushions simultaneously pop up from the air cushion storage chamber 8, and gas reaction starts in the gas generators 9, for automatically and rapidly inflating the cushions for rescue.

In a case where there is not an occupant in the automobile (for example, the automobile is parked in an underground parking lot), if a burst rainstorm occurs and the water level gradually increases, the external water level sensor 5 positioned near the front wheel brake first detects the water level when the automobile fords in water by a height of ⅓ tire height, and the internal water level sensor 6 positioned behind the front wheel mudguard of the automobile detects the water level when the automobile fords in water by a height close to the bottom of the automobile. The first and second grade early warning signal light illuminate successively. There is not an occupant for operating manually to send a rescue instruction, and at this time, the central collaborative processing unit 7 therefore automatically sends a signal for instructing the four sets of air cushion storage chambers to simultaneously eject air cushions, and the gas generators to react and automatically and rapidly inflate the cushions for rescue.

When the automobile floats on water after the rescue cushions are fully inflated, the automobile floats along with a water flow due to influences thereby. At this time, anti-collision walls raised from the four air cushions of the rescue cushions implement a protective function, thereby avoiding damage to the automobile caused by collision between automobiles or collision between the automobile and a building. When the water level reduces to a degree safe for the occupant, the occupant presses the manual button switch for 10 seconds and the central collaborative processing unit 7 processes. Then, the rescue cushions are taken down and separated from inflation mouths, and the automobile can be used normally after cleaning of appearance.

The foregoing embodiments are only descriptions of preferable implementations of the present invention, but are not intended to limit the protection scope of the present invention. Various changes and modifications made to the technical solutions of the present invention by persons of ordinary skill in the art shall all fall within the protection scope of the present invention determined in the claims.

What is claimed is:

1. A novel fully automatic automobile fording rescue system, wherein the system comprises an inflatable rescue cushion at the bottom of an automobile and an electronic early warning and central processing collaboration part;
the inflatable rescue cushion comprises air cushion storage chambers which are located at four positions in front, back, left, and right of the bottom of the automobile, a gas generator is correspondingly arranged in the air cushion storage chamber in each position, and the gas generators are used for inflating and opening air cushions in the corresponding air cushion storage chambers to form a front air cushion, a back air cushion, a left air cushion, and a right air cushion;
the electronic early warning and central processing collaboration part comprises an external water level sensor, a central collaborative processing unit, a first grade early warning signal light, and a manual button switch; and
the external water level sensor is connected to the central collaborative processing unit, the central collaborative processing unit is connected to the first grade early warning signal light, the gas generator, and the automobile computer board; the first grade early warning signal light is positioned in the automobile; and the manual button switch is positioned in the automobile and is connected to the gas generators.

2. The novel fully automatic automobile fording rescue system according to claim 1, further comprising an internal water level sensor located at the inflatable rescue cushion, wherein the internal water level sensor is connected to the central collaborative processing unit.

3. The novel fully automatic automobile fording rescue system according to claim 2, further comprising a second grade early warning signal light positioned in the automobile, wherein the second grade early warning signal light is connected to the central collaborative processing unit.

4. The novel fully automatic automobile fording rescue system according to claim 1, wherein the assembled inflatable rescue cushion having four notches is disposed at corresponding positions in front, back, left, and right of the lower surface of the base plate of the automobile.

5. The novel fully automatic automobile fording rescue system according to claim 1, wherein when the four air cushions of the inflatable rescue cushion are opened, edge portions thereof are located on outer sides of edges of the automobile and extend upwards by 20 to 30 cm.

6. The novel fully automatic automobile fording rescue system according to claim 1, wherein the air cushions are made of a water-proof composite material.

7. The novel fully automatic automobile fording rescue system according to claim 6, wherein the air cushions are made of a water-proof composite material of TPU nylon.
